(19) United States
(12) Patent Application Publication
(10) Pub. No.: US 2009/0173694 A1
(43) Pub. Date: Jul. 9, 2009

(54) ISOPOROUS MEMBRANE AND METHOD OF PRODUCTION THEREOF

(75) Inventors: Klaus-Viktor Peinemann, Geesthacht (DE); Volker Abetz, Aumuhle (DE); Peter F. W. Simon, Reinbek (DE); Greta Johannsen, Hohnstorf (DE)

Correspondence Address: MICHAUD-DUFFY GROUP LLP, 306 INDUSTRIAL PARK ROAD, SUITE 206, MIDDLETOWN, CT, 06457, US

(73) Assignee: GKSS-FORSCHUNGZENTRUM GEESTHACHT GMBH, Geesthacht (DE)

(21) Appl. No.: 12/403,491

(22) Filed: Mar. 13, 2009

Related U.S. Application Data
(63) Continuation of application No. PCT/EP2007/006759, filed on Jul. 31, 2007.

(30) Foreign Application Priority Data
Sep. 22, 2006 (DE) 102006045282.8

(51) Int. Cl. B01D 63/08; B29D 7/01; B29C 39/14; B01D 61/14

(52) U.S. Cl. 210/650; 264/215; 210/500.21; 210/500.22

(57) ABSTRACT

A membrane is produced by dissolving one or more polymers, at least one of which is a block copolymer, in a liquid which includes a solvent, to produce a casting solution. The casting solution is formed into film, and the film is immersed into a precipitation bath which contains at least one non-solvent for the block copolymer so that the film forms a membrane. The membrane is used for filtering a fluid that contains colloidal particles or proteins, and/or for ultrafiltration or nanofiltration, by flowing the fluid through the membrane.

### CROSS-REFERENCE TO RELATED APPLICATION

This is a continuation of International Application PCT/EP2007/006759, with an international filing date of Jul. 31, 2007, which designates the United States of America and which was published on Mar. 27, 2008 under PCT Article 21(2) in German, which is hereby incorporated herein by reference.

### FIELD OF THE INVENTION

The invention relates to a method for the production of membranes, in particular polymer membranes, and to the membranes produced according to this method.

### BACKGROUND

Today, membranes produced according to a so-called phase inversion process are predominantly used for ultrafiltration. These membranes normally have a more or less large statistical variance in the case of the distribution of the pore size, see S. Nunes, K.-V. Peinemann (ed.): Membrane Technology in the Chemical Industry, Wiley-VCH, Weinheim 2006, pages 23-32. A wide variance in the distribution of the pore size has two disadvantages: For one, such a membrane does not permit precise separation of a substances mixture and, on the other hand, such a membrane tends towards so-called fouling. This is understood as a fast blocking of the large pores, since a larger portion of the liquid passing through the membrane first passes through the large pores. It has thus been attempted for some time to produce isoporous membranes, i.e., membranes with a low variance in the distribution of their pore size.

The following methods are known in particular:

Isoporous membranes can be produced using bacterial envelopes, so-called S-layers, see Sleytr et al.: Isoporous ultrafiltration membranes from bacterial cell envelope layers, Journal of Membrane Science 36, 1988. It was thereby determined that these membranes are very difficult to produce in large quantities and that they are not stable over the long term.

Membranes with a low variance in the distribution of their pore size can also be produced through electrolytic oxidation of aluminum, see R. C. Furneaux et al.: The formation of controlled porosity membranes from anodically oxidized aluminium, Nature 337, 1989, pages 147-149. These membranes are offered, for example, under their trade name Anopore®. It has been shown that a significant disadvantage of these membranes is that they are very fragile and very expensive.

Isoporous filter membranes can also be created through lithographic methods, such as the interference lithography, see Kuiper et al: Development and applications of very high flux microfiltration membranes, Journal of Membrane Science 150, 1998, page 1-8. In this case, the microfiltration membranes are also called microsieves. However, membranes with pores with a diameter less than 1 μm cannot be created in this manner. The production method is complex and the membranes are expensive.

Furthermore, it is known to produce isoporous membranes using so-called breath figures, see M. Srinivasaro et al.: Three-dimensionally ordered array of air bubbles in a polymer film, Science 292, 2001, pages 79-83. A moist gas stream is hereby directed in a controlled manner over a solvent-containing polymer film. The pores are created through condensation of water droplets on the surface of the polymer film. It is also not possible here to obtain pores with a sufficiently small diameter.

The large-scale production of membranes is, in particular, difficult and expensive. A newer method for the production of isoporous membranes is based on the self-organization ability of block copolymers, see T. P. Russel et al: Nanoporous membranes with ultrahigh selectivity and flux for the filtration of viruses, Advanced Materials 18, 2006, pages 709-712. Block copolymers are polymers that are made up of more than one type of monomers and whose molecules are linked linearly in blocks. The blocks are interconnected directly or through structural units that are not part of the blocks. In this method, an A-B diblock copolymer is dissolved in a solvent together with a certain amount of homopolymer B.

Through the controlled evaporation of the solvent, films can form on a solid underlay, e.g. a silicon wafer, which have cylinders arranged regularly perpendicular to the surface, which consist of the block B and the homopolymer B. The homopolymer B is dissolved out of these films by a selective solvent so that a nanoporous film is created. The film can now be released by water and transferred to a porous carrier. This creates a composite membrane with an isoporous separation layer. This method is very complex due to the multitude of steps. This method does not allow for the production of membranes on an industrial scale at competitive prices.

### SUMMARY

The present invention resides in one aspect in a method for the production of a membrane by dissolving one or more polymers, at least one of which is a block copolymer, in a liquid comprising a solvent, to produce a casting solution. The casting solution is formed into film, and the film is immersed into a precipitation bath comprising at least one non-solvent for the block copolymer so that the film forms a membrane.

The invention resides in another aspect in a membrane produced by the method described herein.

The invention resides in still another aspect in a method for filtering a fluid that contains colloidal particles or proteins, by flowing the fluid through a membrane as described herein.

The invention resides in yet another aspect in a method for ultrafiltration membrane or nanofiltration of a fluid, by flowing the fluid through a membrane as described herein.

### BRIEF DESCRIPTION OF THE DRAWINGS

FIG. 1 is a photomicrograph showing the upper area of the cross-section of the film from the Example, magnified 20,000 times.

FIG. 2 is a photomicrograph showing the surface of the membrane from the Example, magnified 10,000 times.

FIG. 3 is a photomicrograph showing the surface of the membrane from the Example, magnified 50,000 times.

### DETAILED DESCRIPTION

The present invention provides, in one aspect, a membrane suitable for the ultrafiltration or nanofiltration of colloidal particles or proteins and, in another aspect, a method for the production of such a membrane which is cost-effective and simple to produce.

One embodiment of a method for the production of a membrane yields a polymer membrane which may optionally be an ultrafiltration membrane or nanofiltration membrane. The method includes dissolving of one or more polymers, at least one of which is a block copolymer, in a fluid to provide a casting solution. The fluid comprises at least one solvent for the at least one block copolymer and, optionally, at least one non-solvent. The casting solution is spreading out to form a film. The film is immersed (optionally, dipping) into a precipitation bath which comprises at least one non-solvent for the block copolymer, so that the film forms a membrane. The film may be precipitated and/or induced to form the membrane in the precipitation bath.

Without wishing to be bound by any specific theory, the method described herein is believed to make use of the self-organization ability of at least some block copolymers. For example, as described herein, a block copolymer may be dissolved in a solvent or a solvent mixture, to which additives can also be added to yield a casting solution. Optionally, the casting solution can also contain one or more non-solvents for the block copolylmer in addition to a solvent.

A film is spread out from the casting solution. In one embodiment, after a short evaporation period, the film is dipped into a non-solvent, whereby the precipitation of the polymer film results. Surprisingly, it was determined that during the performance of the method described herein, an asymmetric membrane forms, the separation layer of which contains pores with a low variance of the distribution of the pore size.

In some embodiments of the invention, the distribution of pore diameter in the membrane has a low variance in addition to having a low variance of the distribution of the pore size. Such membranes can be described as isoporous membranes, i.e. membranes that mainly have pores with substantially the same diameter.

As indicated above, it is believed that one aspect of the invention relates to the tendency towards self-organization of at least some block copolymers in regular, microphase-separated structures when combined with a controlled separation process by the addition of a non-solvent. Thus, different thermodynamic effects are triggered simultaneously, which leads to the special integral asymmetric structure, in which the separation-active surface of the membrane is based on the typical microphase morphology of the block copolymer or a blend of block copolymers, wherein this morphology passes seamlessly into a spongy structure of an integral symmetric membrane. An interconnection between the separation layer and the mechanical support layer can thereby be realized in one step.

The method is simple and can be transferred without problems to existing industrial membrane production facilities.

In various embodiments, the at least one block copolymer has a structure of form A-B or A-B-A or A-B-C, wherein A or B or C is polystyrene, poly-4-vinylpyridine, poly-2-vinylpyridine, polybutadiene, polyisoprene, poly(ethylene-stat-butylene), poly(ethylene-alt-propylene), polysiloxane, polyalkylenoxide, poly-ε-caprolactone, polylactide, polyalkylmethacrylate, polymethacrylic acid, polyalkylacrylate, polyacrylic acid, polyhydroxyethylmethacrylate, polyacrylamide or poly-N-alkylacrylamide.

The solvent in the fluid for the casting solution may include dimethylformamide and/or dimethylacetamide and/or N-methylpyrrolidone and/or dimethylsulfoxide and/or tetrahydrofurane.

The precipitation bath may contain water and/or methanol and/or ethanol and/or acetone as the nonsolvent.

The concentration of the one or more polymers dissolved in the casting solution is about 5 to about 30 wt.% (weight percent), optionally about 10 to about 25 wt.% (weight percent), based on the weight of fluid plus the one or more polymers of the casting solution.

In certain embodiments, a membrane produced by a method described herein may bean ultrafiltration membrane or a nanofiltration membrane.

In a specific embodiment the density of surface pores of a membrane produced as described herein is at least about 10⁸ pores/cm².

In another embodiment of a membrane produced as described herein, the diameter of the surface pores in the membrane mainly fulfills the condition that the ratio of the maximum diameter dₘₐₓ to the minimum diameter dₘᵢₙ (i.e., dₘₐₓ:dₘᵢₙ) is less than about three, i.e., less than about 3:1. (Where a ratio of two parameters is described herein by a single value, e.g., a ratio of X, it is to be understood that the ratio referred to is proportion of the stated value to 1, i.e., X:1).

In a particular embodiment, the ratio of the maximum diameter dₘₐₓ to the minimum diameter dₘᵢₙ is less than D, wherein D is to three. D may be about, for example 1.1, 1.2, 1.3, 1.4, 1.5, 1.6, 1.7, 1.8, 1.9 or 2. Alternatively, D may be about, for example, 2.1, 2.2, 2.3, 2.4, 2.5, 2.6, 2.7, 2.8 or 2.9. Thus, the ratio dₘₐₓ:dₘᵢₙ may be about 1 to about 3.

Membranes produced in accordance with certain embodiments of the method described herein are useful for the ultrafiltration or nanofiltration. In particular embodiments, membranes produced in accordance with the method described herein are useful for filtration of colloidal particles or proteins.

The invention is described below, without restricting the general intent of the invention, with reference to an exemplary embodiment and to the drawings, to which we expressly refer with regard to the disclosure of all details that are not disclosed elsewhere herein.

### Example

The block copolymer polystyrene-b-poly-4-vinylpyridine is dissolved in a mixture of dimethylformamide and tetrahydrofurane to provide a casting solution. The composition of the casting solution is 20 wt.% polystyrene-b-poly-4-vinylpyridine (PS-b-P4VP), 20 wt.% tetrahydrofurane (THF), and 60 wt.% dimethylformamide (DMF).

The casting solution is spread out with a doctor knife to a 200-μm-thick film on a glass plate. After 10 seconds, the film is immersed in a water bath. After an hour, the film is removed and air-dried, yielding the membrane.

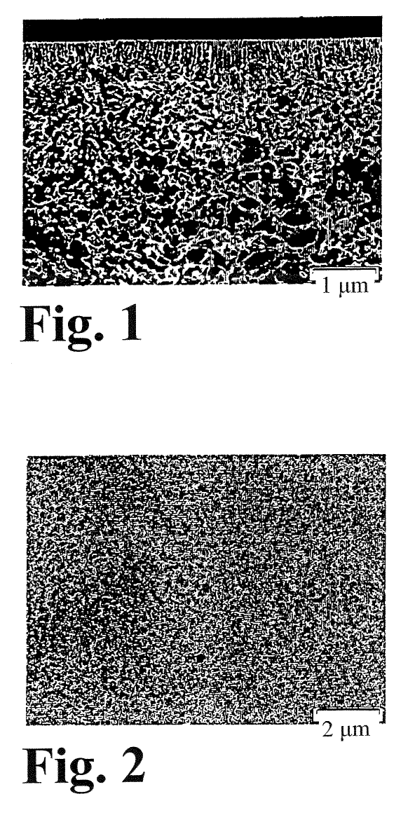

FIG. 1 shows the upper area of the cross-section of the membrane, magnified 20,000 times. The cylindrical pores are clearly detectible on the surface.

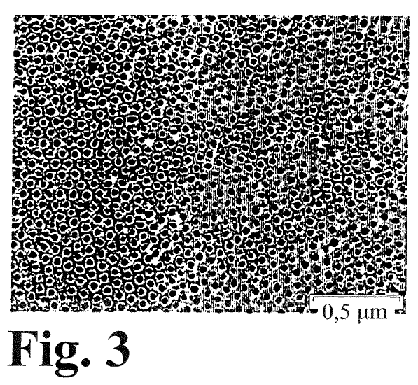

In FIG. 2, the membrane surface is magnified 10,000 times, and in FIG. 3, the membrane surface is magnified 50,000 times

In FIGS. 2 and 3, the surface pores of substantially uniform diameter with a high density can be detected.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the scope of this invention and of the appended claims.

What is claimed is:

1. A method for the production of a membrane, comprising:
dissolving one or more polymers, at least one of which is a block copolymer, in a liquid comprising a solvent to produce a casting solution;
forming a film from the casting solution; and
immersing the film into a precipitation bath comprising at least one non-solvent for the block copolymer so that the film forms a membrane.

2. The method according to claim 1, wherein the block copolymer has a structure of form A-B or A-B-A or A-B-C, wherein A or B or C is polystyrene, poly-4-vinylpyridine, poly-2-vinylpyridine, polybutadiene, polyisoprene, poly(ethylene-stat-butylene), poly(ethylene-alt-propylene), polysiloxane, polyalkylenoxide, poly-ε-caprolactone, polylactide, polyalkylmethacrylate, polymethacrylic acid, polyalkylacrylate, polyacrylic acid, polyhydroxyethylmethacrylate, polyacrylamide or poly-N-alkylacrylamide.

3. The method according to claim 1 wherein the liquid comprises dimethylformamide, dimethylacetamide, N-methylpyrrolidone, dimethylsulfoxide, tetrahydrofurane or a combination of two or more thereof.

4. The method according to wherein the precipitation bath comprises water, methanol, ethanol, acetone, or a combination of two or more thereof.

5. The method according to claim 1, wherein the concentration of block copolymer plus any other polymer dissolved in the casting solution is about 5 to about 30 wt. % based on the weight of polymers plus liquid in the casting solution.

6. A membrane having a plurality of pores, produced according to the method of claim 1.

7. The membrane according to claim 6, including surface pores, wherein the density of surface pores of the membrane is at least about 10⁸ pores/cm².

8. The membrane according to claim 6, including surface pores, wherein the surface pores have pore diameters including a maximum pore diameter dₘₐₓ and a minimum pore diameter dₘᵢₙ, and wherein the ratio of the maximum pore diameter dₘₐₓ to the minimum pore diameter dₘᵢₙ is less than about three.

9. The membrane according to claim 6, including surface pores, wherein the surface pores have pore diameters including a maximum pore diameter dₘₐₓ and a minimum pore diameter dₘᵢₙ, and wherein the ratio of the maximum pore diameter dₘₐₓ to the minimum pore diameter dₘᵢₙ is about 1 to about 3.

10. The membrane according to claim 6, including surface pores, wherein the membrane is an ultrafiltration membrane or nanofiltration membrane.

11. A method for filtering a fluid containing colloidal particles or proteins, comprising flowing the fluid through a membrane according to claim 6.

12. The method of claim 11, wherein the membrane is an ultrafiltration membrane or nanofiltration membrane.

13. A method for ultrafiltration or nanofiltration of a fluid, comprising flowing the fluid through a membrane according to claim 6.
